(19) United States
(12) Patent Application Publication
(10) Pub. No.: US 2007/0119141 A1
(43) Pub. Date: May 31, 2007

(54) Multiple head raking device

(76) Inventor: Jonathan G. Foss, Shorewood, MN (US)

Correspondence Address: Mark A. Litman & Associates, P.A.;York Business Center, Suite 205, 3209 West 76th St., Edina, MN, 55435, US

(21) Appl. No.: 11/287,648

(22) Filed: Nov. 28, 2005

(51) Int. Cl. A01D 7/00

(52) U.S. Cl. 56/400.16

(57) ABSTRACT

An efficient raking device has a handle with a gripping end and a raking end. The raking end has at least a first rake head and a second rake head. The two rake heads are disposed so that a) when the raking end is pressed firmly against a ground surface ends tines of each of the at least two rake heads contact the ground surface; and b) pointed ends of the tines on each rake head contact the ground surface, with pointed ends of tines on the first rake head being more distal from the gripping end than pointed ends of tines of the second rake head. The first rake head is relatively closer to the ground surface when the device is in a raking position, and the first rake head may be able to pivot away from the second rake head when the device is held relatively horizontally over the ground surface.

### BACKGROUND OF THE INVENTION

1. Field of the Invention

The present invention relates to devices for removing waste from the ground, especially the raking of waste materials, such as trash, leaves, grass, cut flora and the likie from the ground, as in raking of materials for removal.

2. Background of the Art

Many different types of devices have been designed for the removal of clutter or waste materials that are deposited on the ground. The simplest of the devices are little more than a pointed stick that pierces and retains a target on the stick to enable it to be lifted from the ground. The most common device for the removal of waste from the ground, and especially leaves, cut grass and cut flora (from bushes and trees) is the rake. A rake generally consists of a handle on one end and a multi-pronged raking end. The raking end contains a multiplicity of elongate, flexible elements that typically fan out or lie parallel to each other forming a set of spaced elongate elements that can scrape the ground to move the material to be raked. The elongate elements are known as tines, and each tine originally comprised a strip of cane. To improve the ability of the tine in gripping material, such as leaves, retaining the material, and allowing larger amounts of materials to be moved, the ends of the tines that contact the ground are curved or bent towards the ground to form a claw-like element that forms a barrier against the leaves being able to slide underneath a flat (uncurved) tine.

Numerous modifications have been made in rake design. Among the more common design changes is the addition of a swiveling or pivoting opposed set of tongs to act like jaws, gripping a pile of leaves, after they have been raked into a pile, so that portions of the pile for depositing the raked material into a storage device. Examples of these many variants include U.S. Patents and Published Applications Nos. 20020073680; 20040134178; U.S. Pat. Nos. 6,502,381; 6,134,869; 4,930,824; 4,545,189; 4,378,671; and 4,291,794.

### SUMMARY OF THE INVENTION

A raking device comprises at least two sets of rake heads with the ends of the tines facing in the same, relatively downward direction. The sets of at least two rake heads are configured together so that the line of tines with each rake head are spaced apart to allow leaves to collect under each rake head. Leaves that collect between the adjacent rake heads can be shaken from between the rake heads or at least one of the rake heads may be enabled for pivoting to allow separation of the rake heads and allowing leaves to free fall from between the rake heads for depositing them into a pile or container or to just clear the rake heads from retained leaves.

### BRIEF DESCRIPTION OF THE FIGURES

FIG. 1 shows a typical prior art rake head with curved tines.

FIG. 2 shows a side view of multiple rake head orientation according to the invention.

FIG. 3 shows a multiple rake head device with a self-clearing pivoting rake head.

### DETAILED DESCRIPTION OF THE INVENTION

A raking device according to the present invention comprises a handle that supports a raking system comprising multiple rake heads the tines of which face in the same general direction. The use of multiple rake heads assists in enabling more detritus to be collected with each raking action, less clogging of tines in each rake head and an overall improvement in raking efficiency.

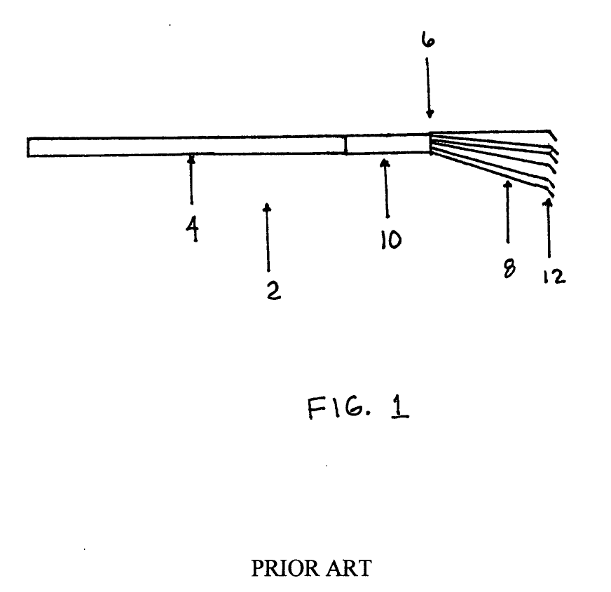

As shown in FIG. 1, a prior art rake 2 comprises a handle 4, and a rake head 6. The rake head 6 usually comprises multiple tines 8 with a structural support 10 for the tines 8. The tines 8 have curved ends 12 that assist in gripping leaves as the rake 2 is pulled along the ground.

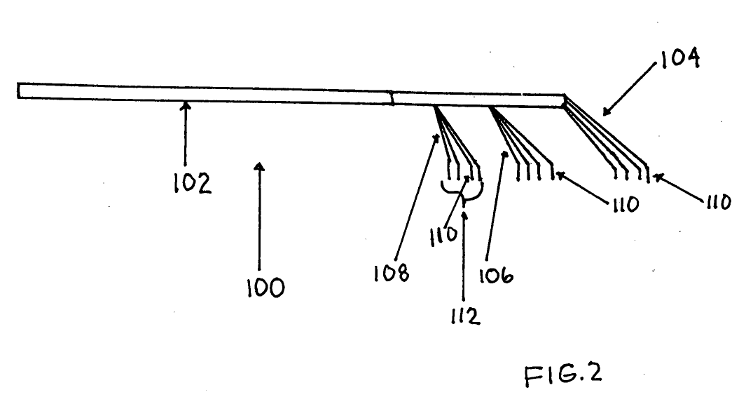

FIG. 2 shows a side view of a multiple rake head raking device 100. The raking device 100 comprises a handle 102, an upper rake head 104 and a first lower rake head 106 and a second lower rake head 108. As can be readily seen, tines 110 on the various rake heads 104, 106 and 108 extend in the same general direction, facing towards a surface to be raked. It cannot be seen that the tines 110 (and to some degree the rake head) are flexible and that each tine 110 conforms to the surface being raked.

In operation, the raking device 100 will have the rake heads 104, 106 and 108 dragged along the ground towards the handle 102 such that the second lower rake head 108 grabs at leaves on the ground and starts to collect them behind or under the tines 110 on the second lower rake head 108 and under the elongated section 112 of the tines 110 on the second lower rake head 108. As the second lower rake head 108 fills, leaves pass under the tines 110 of the second lower rake head 108 to contact the tines 110 of the first lower rake head 106. A similar process occurs between the upper rake head 104 and the first lower rake head 106. An interesting point to note is that the function and benefits of the multiple rake heads is different from the function and benefit of the use of multiple shaving heads or blades. As well advertised, the first of two multiple shaving heads cuts and extends a hair, and the second head or blade catches the extended hair and cuts the hair lower along the follicle. That functional mechanism has no relevance to the performance of the rake system described herein. The leaves are moveable not fixed, the leaves are not cut, and the following rake head contacts leaves that have completely passed by a lower rake head. Instead, the rake system described herein provides a backup catch system for passed leaves, and allows ready removal of leaves from between rake heads. The rake system enables higher efficiency raking And leaves fewer leaves in the path of the raking, which reduces the need for multiple strokes over the same area to be raked.

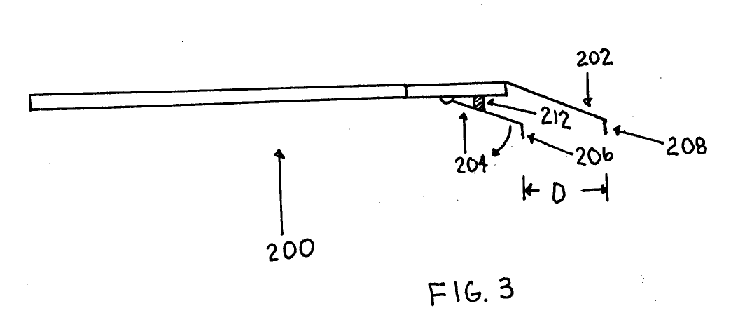

FIG. 3 shows a side view of a rake system 200 in which only two rake heads 202 and 204 are shown for convenience. The two rake heads 202 and 204 have a separation D between the locus line of tines 206 and 208 from the upper rake head 202 and the lower rake head 204. Where the lower rake head 204 attaches to the handle 210 there is a connection 212 that allows the lower rake head 204 to brace itself against either or both of the handle 210 and/or the upper rake head 202. By bracing itself in the upward rotation direction, the lower rake head 204 can provide force against the ground during raking. If the upper rake head 202 were allowed to pivot, the upper rake head 202 would bounce or float over the ground with little force.

One benefit of the pivoting lower rake head 204 is the ability, once the rake 200 is lifted, the lower rake head 204 can pivot (with or without clearing any locking mechanism) so that the lower head 204 can pivot freely, expanding the space between the two rake heads 202 and 204, which will allow leaves that collect between the two rake heads 202 and 204 to freely fall from between those rake heads. The pivoting rake head(s) such as the lower rake head 204 can be free swinging or may lock into a fixed relationship with the adjacent head and then be unlocked to release any entrapped leaves, as by a pin (not shown) or levered locking system (not shown). The lower rake head 204 flexes when pressed against the ground, and this tends to close or restrict the spacing between adjacent rake heads, which limits entry of leaves between rake heads, and reduces the need for repeated leaf removal. However, some entrapment does occur and the ability to freely pivot the lower rake head 204 assist in reducing the annoying time delays when leaves must be removed.

Another way of describing the technology of the presently disclosed raking device is a structure comprising a handle having a gripping end and a raking end. The raking end comprises at least two rake heads as a first rake head and a second rake head. The two rake heads are disposed so that:
when the raking end is pressed firmly against a ground surface, ends tines of each of the at least two rake heads contact the ground surface; and
pointed ends of the tines are the ends of the tine that contact the ground surface, with pointed ends of tines on the first rake head being more distal from the gripping end than pointed ends of tines of the second rake head.
   By “pointed ends” it is not required that the ends of the tines that contact the ground be actually sharply pointed, but means only the ends of the tines that are intended to contact the ground surface. The actual ends of the tines, as known in the art, may be flat, curved, pointed or otherwise shaped in a working ‘pointed end’ as known in the art.

The raking device has an approximate general direction or length lying along a direction between a hand-held end of the gripping end and the raking end that shall be considered a length of the device. There is an average separation between closest pointed ends of tines on the first rake head and pointed tines on the second rake head of between 4 and 40 cm, preferably between 5 and 30 cm. By closest tine is meant (for example) looking along a line of site down a tine on a first rake head, a tine on the second rake head can be seen that in closest in distance (considering three dimensions) to the end of that tine. When considering the locus of tines within each rake head (as later described), this distance can actually be better considered as the average distance between the loci of tines on the first rake head as compared to the loci of tines on the second rake head.

The term “rake head” does not necessarily mean that such a structure (the component that supports a row of tines) needs to be a separate element attached at its own distinct location along the elongate handle element. Although the structure may have distinct rake heads separately attached to the handle, a single support structure attached to the handle may have the tines and their supports spread long the length of the support structure.

The length of the raking device and orientation of elements thereon is such that tines of the first rake head are closest to the gripping end of the device, the first rake head being relatively closer to the ground surface when the device is in a raking position. The first rake head is preferably able to pivot away from the second rake head when the device is held relatively horizontally over the ground surface with the first rake head closest to the ground surface in comparison with the second rake head. Any pivoting or swiveling component can enable this motion, such as a pinned hinge, ball hinge, living hinge (less preferred because of structural weakness), and the like.

The raking device may have elongate handle element comprising the gripping end and at least the second rake head is physically secured proximally at the raking end of the device. The physical securement may be relatively permanent (e.g., bolt, staples, nails, adhesive, etc.) or such that the second rake head may be removed and reattached to the elongate handle without damage to the elongate handle or the second rake head, as by a screwing handle/head relationship with the hand as either a male coupling or preferably a female coupling, toggled clip, snap clips, levered clips, pinned attachments and the like. The same type of engagement between the handle and the first rake head may be provided.

As noted earlier, the raking device may have a locus of ends of tines on the first rake head and a locus of tines on the second rake head are each defined by an approximately straight line, curve (arc) or other functional shape or design. There may be an elongate handle element comprising the gripping end wherein the second rake head is at an angle with respect to the elongate handle that is closer to parallellity with the handle than an angle between the first rake and the elongate handle. The handle does not have to be straight, but may be more ergonomically shaped so that less bending is required by the user. This may be accomplished by having a significant bend or arc along the handle. It is preferred that there is a locking system present that prevents pivoting of the first rake head until the locking device is positioned into an unlocked position, although the free swinging (without locking mechanism) action is functionally sufficient.

The locus of the ends of the tines may be a straight line or as curve, and the spacing between tines is large enough for the individual tines to flex and yet not easily overlap, one another. The end points of the tines may be in a straight line, in an arc, in a combination of these, show a stepped orientation, and the like. It is preferred, but not essentially, that the end lines of the multiple rake heads be relatively parallel to each other, but this again is not essential.

Although specific terms and structures have been provided to enable those skilled in the art, these specifics are merely representative descriptions within the generic concepts disclosed herein. The materials used in the construction are well within the design choices of the ordinary skilled artisan and include natural materials (e.g., wood, cane, etc.) and synthetic materials (e.g., metals, plastics, composites, etc.).

1. A raking device comprising a handle having a gripping end and a raking end,
the raking end comprising at least two rakes heads of a first rake head most distal from the gripping end and a second rake head most proximal to the gripping end, the two rake heads disposed so that:
a) when the raking end is pressed firmly against a ground surface ends tines of each of the at least two rake heads contact the ground surface; and
b) pointed ends of the tines are the ends of the tine that contact the ground surface, with pointed ends of tines on the first rake head being more distal from the gripping end than pointed ends of tines of the second rake head,
wherein the at least two rake heads are disposed along the handle as:
c) distinct rake heads separately attached to the handle at different positions along the handle, or
d) supports for each of the rake heads spread long the length of the support structure.

2. The raking device of claim 1 wherein a direction between an end of the gripping end and an end of the raking end is considered a length of the device and there is an average separation between closest pointed ends of tines on the first rake head and pointed tines on the second rake head of between 6 and 30 cm.

3. The raking device of claim 1 wherein a direction between an end of the gripping end and an end of the raking end is considered a length of the device and the tines of the second rake head are closest to the gripping end of the device, the second rake head being relatively closer to the ground surface when the device is in a raking position, and the second rake head is able to pivot away from the first rake head when the device is held relatively horizontally over the ground surface with the second rake head closest to the ground surface in comparison with the first rake head.

4. The raking device of claim 1 wherein there is an elongate handle element comprising the gripping end and at least the second rake head is physically secured proximally at the raking end of the device.

5. The raking device of claim 4 wherein the second rake head may be removed and reattached to the elongate handle without damage to the elongate handle or the second rake head.

6. The raking device of claim 4 wherein the first rake head may be removed and reattached to the elongate handle without damage to the elongate handle or the first rake head.

7. The raking device of claim 6 wherein the second rake head may be removed and reattached to the elongate handle without damage to the elongate handle or the second rake head.

8. The raking device of claim 1 wherein a locus of ends of tines on the first rake head and a locus of tines on the second rake head are each defined by an approximately straight line.

9. The raking device of claim 1 wherein a locus of ends of tines on the first rake head and a locus of tines on the second rake head are each defined by a curved line.

10. The raking device of claim 1 wherein there is an elongate handle element comprising the gripping end and the second rake head is at an angle with respect to the elongate handle that is closer to parallellity with the handle than an angle between the first rake and the elongate handle.

11. The raking device of claim 2 wherein there is an elongate handle element comprising the gripping end and the second rake head is at an angle with respect to the elongate handle that is closer to parallellity with the handle than an angle between the first rake and the elongate handle.

12. The raking device of claim 3 wherein there is an elongate handle element comprising the gripping end and the second rake head is at an angle with respect to the elongate handle that is closer to parallellity with the handle than an angle between the first rake and the elongate handle.

13. The raking device of claim 4 wherein there is an elongate handle element comprising the gripping end and the second rake head is at an angle with respect to the elongate handle that is closer to parallellity with the handle than an angle between the first rake and the elongate handle.

14. The raking device of claim 3 wherein a locking system is present that prevents pivoting of the first rake head until the locking device is positioned into an unlocked position.

15. The raking device of claim 12 wherein a locking system is present that prevents pivoting of the first rake head until the locking device is positioned into an unlocked position.

16. A raking device comprising a handle having a gripping end and a raking end,
the raking end comprising at least two rakes heads of a first rake head most distal from the gripping end and a second rake head most proximal to the gripping end, the two rake heads disposed so that:
a) when the raking end is pressed firmly against a ground surface ends tines of each of the at least two rake heads contact the ground surface; and
b) pointed ends of the tines are the ends of the tine that contact the ground surface, with pointed ends of tines on the first rake head being more distal from the gripping end than pointed ends of tines of the second rake head,
wherein the at least two rake heads are disposed along the handle as:
c) distinct rake heads separately attached to the handle at different positions along the handle, or
d) supports for each of the rake heads spread long the length of the support structure,
and wherein the tines of the first rake head and the tines of the second rake head do not intersect each.

17. The raking device of claim 16 wherein a direction between an end of the gripping end and an end of the raking end is considered a length of the device and there is an average separation between closest pointed ends of tines on the first rake head and pointed tines on the second rake head of between 6 and 30 cm.

18. The raking device of claim 16 wherein a direction between an end of the gripping end and an end of the raking end is considered a length of the device and the tines of the second rake head are closest to the gripping end of the device, the second rake head being relatively closer to the ground surface when the device is in a raking position, and the second rake head is able to pivot away from the first rake head when the device is held relatively horizontally over the ground surface with the second rake head closest to the ground surface in comparison with the first rake head.
